(19) United States
(12) Patent Application Publication
(10) Pub. No.: US 2014/0120925 A1
(43) Pub. Date: May 1, 2014

(54) MOBILE STATION WITH MULTI-SIM AND TUNE AWAY METHODS

(71) Applicant: QUALCOMM INCORPORATED, San Diego, CA (US)

(72) Inventors: Venkata Raji Reddy Kanthala, Hyderabad (IN); Mungal Singh Dhanda, Slough (GB); Subbarayudu Mutya, Hyderabad (IN)

(73) Assignee: Qualcomm Incorporated, San Diego, CA (US)

(21) Appl. No.: 13/758,719

(22) Filed: Feb. 4, 2013

Related U.S. Application Data
(63) Continuation-in-part of application No. 13/739,738, filed on Jan. 11, 2013.
(60) Provisional application No. 61/721,118, filed on Nov. 1, 2012.

(51) Int. Cl. H04W 88/10; H04W 72/04

(52) U.S. Cl. CPC H04W 88/10; H04W 72/04
USPC 455/450

(57) ABSTRACT

Apparatus and methods are disclosed to provide for a multi-SIM wireless user equipment configured for autonomous tune-away operations enabling simultaneous communication on multiple subscriptions using a shared RF chain while maintaining a voice call. A multi-SIM user equipment may be capable of communicating with a first subscription and a second subscription via a transceiver. The user equipment may be engaged in circuit switched communication utilizing a first channel corresponding to the first subscription associated with a first USIM; and the transceiver may be autonomously tuned away from the first channel and tuned to a second channel corresponding to the second subscription associated with a second USIM, while the circuit switched communication is ongoing, and autonomously tuned back to the first channel. Other aspects, embodiments, and features are also claimed and described.

### PRIORITY CLAIM & RELATED APPLICATIONS

This patent application claims priority to U.S. Provisional Application No. 61/721,118, filed 1 Nov. 2012, which is hereby incorporated herein by reference as is fully set forth below and for all applicable purposes.

This patent application is related to and is a continuation-in-part of U.S. Non-Provisional application Ser. No. 13/739,738, filed 11 Jan. 2013, which is hereby incorporated herein by reference as if fully set forth below and for all applicable purposes.

### TECHNICAL FIELD

The technology discussed in this patent application relates generally to wireless communication systems, and more particularly, to mobile stations equipped to operate with two subscriptions and methods of operating the same. Embodiments enable communications to occur on multiple subscriptions to ensure that the multiple communication connections remain connected.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is a global system for mobile (GSM) network.

Generally, wireless mobile equipment (called mobile station, MS, user equipment or UE in 3GPP terminology such as GSM, but also called access terminal, etc. in various literature) configured for EGPRS uses a SIM/USIM card (subscriber identity module/universal subscriber identity module) to store the subscriber's identity and for other security and authentication purposes. Recently, some UEs have multi-SIM capability, such that a device user can engage in calls on multiple subscriptions. These subscriptions might be on the same network or on different networks. Some multi-SIM mobile devices only utilize a single transceiver, which is shared for use by both subscriptions. As a result, there are certain limitations on carrying communications concurrently on both subscriptions.

### BRIEF SUMMARY OF SOME EXAMPLE EMBODIMENTS

The following presents a simplified summary of one or more aspects of the present disclosure to provide a basic understanding of the discussed technology. This summary is not an extensive overview of all features of the disclosure, and is intended neither to identify key or critical elements of all aspects of the disclosure nor to delineate the scope of any or all aspects of the disclosure. Its sole purpose is to present some concepts of one or more aspects of the disclosure in a summary form as a prelude to the more detailed description that is presented later.

Apparatus and methods are disclosed to provide for wireless user equipment or mobile station configured for tune-away operations enabling concurrent or simultaneous communication on multiple subscriptions using a shared RF chain while maintaining a circuit switched communication (e.g., voice call). The user equipment may be equipped with multiple USIMs (e.g., dual-USIM) and may be capable of communicating with a first subscription and a second subscription via the same transceiver or RF chain. Hereafter, the terms “user equipment” and “mobile station” may be used interchangeably and the terms USIM and SIM may be used interchangeably in this disclosure.

In one aspect, the disclosure provides a method of wireless communication operable at a multi-SIM mobile station capable of communicating with a first subscription associated with a first USIM and a second subscription associated with a second USIM via a transceiver. The method includes engaging in circuit switched communication utilizing a first channel corresponding to the first subscription associated with the first USIM; autonomously tuning the transceiver away from the first channel and tuning to a second channel corresponding to the second subscription associated with the second USIM, while the circuit switched communication is ongoing; and autonomously tuning the transceiver back to the first channel. In some aspects, the first channel may be traffic channel (TCH) or slow associated control channel (SACCH), and the second channel may be common control channel (CCCH), a standalone dedicated control channel (SDCCH) or slow associated control channel (SACCH). The common control channel (CCCH) is a term used for channels such as paging channel (PCH), broadcast channel (BCCH), access grant channel (AGCH), etc.

Another aspect of the disclosure provides a multi-SIM mobile station capable of communicating with a first subscription associated with a first USIM and a second subscription associated with a second USIM via a transceiver. The multi-SIM mobile station includes: means for engaging in circuit switched communication utilizing a first channel corresponding to the first subscription associated with the first USIM; means for autonomously tuning the transceiver away from the first channel and tuning to a second channel corresponding to the second subscription associated with the second USIM, while the circuit switched communication is ongoing; and means for autonomously tuning the transceiver back to the first channel.

Another aspect of the disclosure provides a computer program product, including a computer-readable storage medium including code for causing a multi-SIM mobile station capable of communicating with a first subscription associated with a first USIM and a second subscription associated with a second USIM via a transceiver to: engage in circuit switched communication utilizing a first channel corresponding to the first subscription associated with the first USIM; autonomously tune the transceiver away from the first channel and tune to a second channel corresponding to the second subscription associated with the second USIM, while the circuit switched communication is ongoing; and autonomously tune the transceiver back to the first channel.

Another aspect of the disclosure provides a multi-SIM mobile station capable of communicating associated with a first subscription and a second subscription. The multi-SIM mobile station includes: at least one processor; a first USIM associated with the first subscription and coupled to the at least one processor; a second USIM associated with the second subscription and coupled to the at least one processor; a transceiver coupled to the at least one processor; and a memory coupled to the at least one processor. The at least one processor is configured to: engage in circuit switched communication utilizing a first channel corresponding to the first subscription associated with the first USIM; autonomously tune the transceiver away from the first channel and tune to a second channel corresponding to the second subscription associated with the second USIM, while the circuit switched communication is ongoing; and autonomously tune the transceiver back to the first channel.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram conceptually illustrating an example of a telecommunications system according to some embodiments.

FIG. 2 is a conceptual diagram illustrating an example of an access network according to some embodiments.

FIG. 3 is a block diagram illustrating an example of a hardware implementation for a user equipment employing a processing system according to some embodiments.

FIG. 4 is a conceptual diagram illustrating a user equipment configured to operate in a first communication network and a second communication network according to some embodiments.

FIG. 5 is a conceptual diagram illustrating a physical channel structure for Global System for Mobile Communications (GSM) during a call setup phase according to some embodiments.

FIG. 6 is a conceptual diagram illustrating a physical channel structure of traffic channels (TCH) for GSM during an ongoing call according to some embodiments.

FIG. 7 is a flow chart illustrating a tune-away scheme according to some embodiments.

FIG. 8A is a conceptual diagram illustrating a tune-away scheme according to some embodiments.

FIG. 8B is a conceptual diagram illustrating a tune-away scheme according to some embodiments.

FIGS. 9 and 10 illustrate a flow chart of another tune-away scheme according to some embodiments.

FIG. 11 is a flowchart illustrating a tune-away scheme according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

One or more aspects of the disclosure provide for a wireless user equipment (UE) configured to enable communication with two or more subscriptions, wherein each subscription may be in the same or in different radio access technologies (RAT). The UE may have multiple USIM applications or SIMs. Specific examples are provided below with reference to a GSM/EDGE Radio Access Network (GERAN) system. However, the concepts disclosed can be applied to any time-division-based system, such as but not limited to a UMTS system using a TDD air interface, or an e-UTRA system using a TD-LTE air interface. Especially in the multi-SIM (e.g., dual-SIM) examples, the subscriptions might be on any of these types of systems.

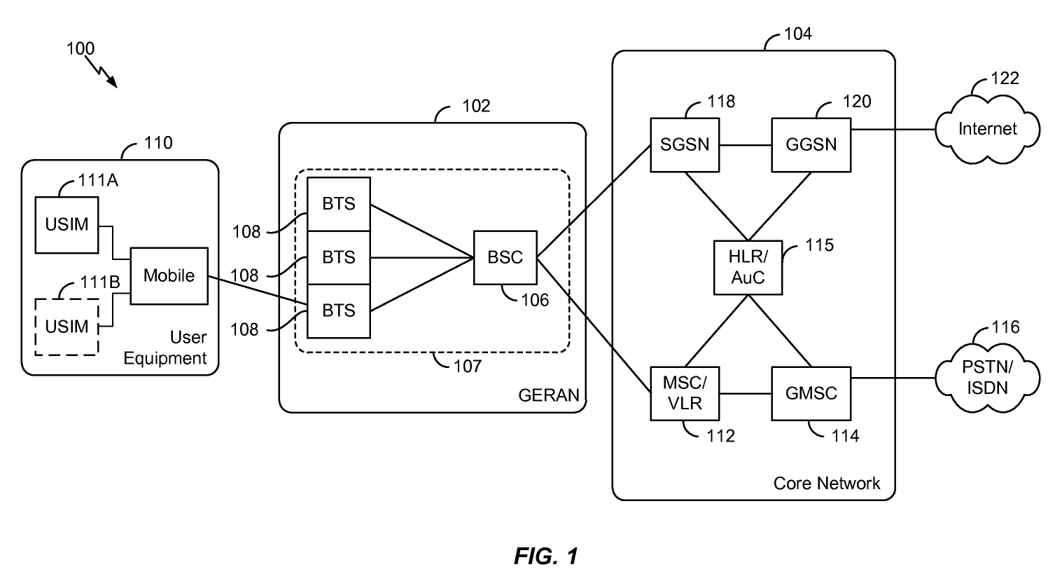

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a Global System for Mobile (GSM) system 100. A GSM network includes three interacting domains: a core network 104 (e.g., a GSM/GPRS core network), a radio access network (RAN) (e.g., the GSM/EDGE Radio Access Network (GERAN) 102), and user equipment (UE) 110. In this example, the illustrated GERAN 102 may employ a GSM air interface for enabling various wireless services including telephony, video, data, messaging, broadcasts, and/or other services. The GERAN 102 may include a plurality of Radio Network Subsystems (RNSs) such as an RNS 107, each controlled by a respective Base Station Controller (BSC) such as a BSC 106. Here, the GERAN 102 may include any number of BSCs 106 and RNSs 107 in addition to the illustrated BSCs 106 and RNSs 107. The BSC 106 is an apparatus responsible for, among other things, assigning, reconfiguring, and releasing radio resources within the RNS 107.

The geographic region covered by the RNS 107 may be divided into a number of cells, with a radio transceiver apparatus serving each cell. A radio transceiver apparatus is commonly referred to as a base transceiver station (BTS) in GSM applications, but may also be referred to by those skilled in the art as a base station (BS), a Node B, a radio base station, a radio transceiver, a transceiver function, a basic service set (BSS), an extended service set (ESS), an access point (AP), or some other suitable terminology. For clarity, three BTSs 108 are shown in the illustrated RNS 107; however, the RNSs 107 may include any number of wireless BTSs 108. The BTSs 108 provide wireless access points to a GSM/GPRS core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning devices. The mobile apparatus is commonly referred to as user equipment (UE) in GSM applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology.

The GSM “Um” air interface generally utilizes GMSK modulation (although later enhancements such as EGPRS, described below, may utilize other modulation such as 8PSK), combining frequency hopping transmissions with time division multiple access (TDMA), which divides a frame into 8 time slots. Further, frequency division duplexing (FDD) divides uplink and downlink transmissions using a different carrier frequency for the uplink than that used for the downlink. Those skilled in the art will recognize that although various examples described herein may refer to GSM Um air interface, the underlying principles are equally applicable to any other suitable air interfaces.

In some aspects of the disclosure, the GSM system 100 may be further configured for enhanced GPRS (EGPRS). EGPRS is an extension of GSM technology providing increased data rates beyond those available in 2G GSM technology. EGPRS is also known in the field as Enhanced Data rates for GSM Evolution (EDGE), and IMT Single Carrier.

Specific examples are provided below with reference to the GERAN system. However, the concepts disclosed in various aspects of the disclosure can be applied to any time-division-based system, such as but not limited to a UMTS system using a TDD air interface, or an e-UTRA system using a TD-LTE air interface. Especially in the multi-SIM examples (described in further detail below), the multiple subscriptions might be on any one or more of these systems.

That is, in some aspects of the disclosure, the UE 110 may include a plurality of universal integrated circuit cards (UICC), each of which may run one or more universal subscriber identity module (USIM) applications 111. A USIM stores the subscriber's identity, and provides a user's subscription information to a network as well as performing other security and authentication roles. The illustrated UE 110 includes two USIMs 111A and 111B, but those of ordinary skill in the art will understand that this is illustrative in nature only, and a UE may include any suitable number of USIMs. UEs such as the UE 110 having multiple USIMs are sometimes referred to as multi-SIM/multiple standby devices, with one particular with two USIMs example being called Dual SIM Dual Standby (DSDS) device or dual-SIM device. A DSDS device is generally capable of being active on two networks concurrently or simultaneously in standby mode, where a transceiver at the UE 110 is time-shared by two subscriptions on the respective networks. In this way, connections or calls may be established on either of the networks or subscriptions with a single device.

For illustrative purposes, one UE 110 is shown in communication with one BTS 108 in FIG. 1. The downlink (DL), also called the forward link, refers to the communication link from a BTS 108 to a UE 110, and the uplink (UL), also called the reverse link, refers to the communication link from a UE 110 to a BTS 108.

The core network 104 can interface with one or more access networks, such as the GERAN 102. As shown, the core network 104 is a GSM core network. However, as those skilled in the art will recognize, the various concepts presented throughout this disclosure may be implemented in a RAN, or other suitable access network, to provide UEs with access to types of core networks other than GSM networks.

The illustrated GSM core network 104 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 104 supports circuit-switched services with a MSC 112 and a GMSC 114. In some applications, the GMSC 114 may be referred to as a media gateway (MGW). One or more BSCs, such as the BSC 106, may be connected to the MSC 112. The MSC 112 is an apparatus that controls call setup, call routing, and UE mobility functions. The MSC 112 also includes a visitor location register (VLR) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) 115 containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR 115 to determine the UE's location and forwards the call to the particular MSC serving that location.

The illustrated core network 104 also supports packet-switched data services with a serving GPRS support node (SGSN) 118 and a gateway GPRS support node (GGSN) 120. General Packet Radio Service (GPRS) is designed to provide packet-data services at speeds higher than those available with standard circuit-switched data services. The GGSN 120 provides a connection for the GERAN 102 to a packet-based network 122. The packet-based network 122 may be the Internet, a private data network, or some other suitable packet-based networks. The primary function of the GGSN 120 is to provide the UEs 110 with packet-based network connectivity. Data packets may be transferred between the GGSN 120 and the UEs 110 through the SGSN 118, which performs primarily the same functions in the packet-based domain as the MSC 112 performs in the circuit-switched domain.

As described above, the illustrated UE 110 is a DSDS device capable of maintaining two subscriptions on the GSM network 100 and or other networks. Within the scope of the present disclosure, similar functionality may be achieved utilizing more than one radio access technology (RAT), wherein the UE simultaneously maintains two or more subscriptions on two or more different RATs. Here, such a UE may maintain one or more subscriptions on one or more of a GSM network, a UMTS network, an LTE network, a cdma2000 network, a Wi-MAX network, or any other suitable RAT. Within the present disclosure, DSDS devices, multi-SIM/multiple standby devices, or any device capable of monitoring channels on two or more subscriptions on any one or any plural number of RATs is generally referred to as a multiple standby device.

On a multiple standby UE 110, compromises are typical to allow sharing of the radio transceiver between two or more separate user subscriptions. That is, the UE 110 generally cannot be guaranteed to be listening to all of the required radio channels for each subscription at the same time, and thus, may miss paging messages on one subscription when engaged in a communication activity utilizing the other subscription. Most cellular network implementations do allow for broadcast information (such as paging) to be repeated a finite number of times over multiple cycles, but do not provide any mechanism for the subscriber devices to know what this repetition pattern might be. Thus, there remains a possibility that such broadcast information might be missed by a UE engaged in a communication activity utilizing a different subscription or channel.

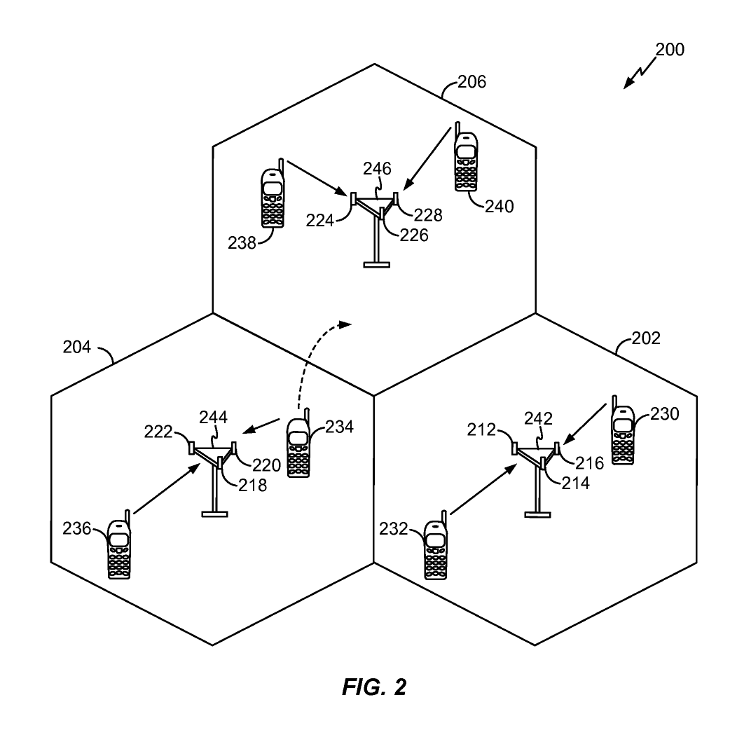

The GERAN 102 is one example of a RAN that may be utilized in accordance with the present disclosure. Referring to FIG. 2, by way of example and without limitation, a simplified schematic illustration of a RAN 200 in a GERAN architecture is illustrated. The system includes multiple cellular regions (cells), including cells 202, 204, and 206, each of which may include one or more sectors. Cells may be defined geographically, e.g., by coverage area. In a cell that is divided into sectors, the multiple sectors within a cell can be formed by groups of antennas with each antenna responsible for communication with UEs in a portion of the cell. For example, in cell 202, antenna groups 212, 214, and 216 may each correspond to a different sector. In cell 204, antenna groups 218, 220, and 222 may each correspond to a different sector. In cell 206, antenna groups 224, 226, and 228 may each correspond to a different sector.

The cells 202, 204, and 206 may include several UEs that may be in communication with one or more sectors of each cell 202, 204, or 206. For example, UEs 230 and 232 may be in communication with a BTS 242, UEs 234 and 236 may be in communication with a BTS 244, and UEs 238 and 240 may be in communication with a BTS 246. Here, each BTS 242, 244, and 246 may be configured to provide an access point to a core network 104 (see FIG. 1) for all the UEs 230, 232, 234, 236, 238, and 240 in the respective cells 202, 204, and 206.

During a call with a source cell, or at any other time, the UE 236 may monitor various parameters of the source cell as well as various parameters of neighboring cells. Further, depending on the quality of these parameters, the UE 236 may maintain communication with one or more of the neighboring cells. During this time, the UE 236 may maintain an Active Set, that is, a list of cells to which the UE 236 is simultaneously connected (e.g., the UMTS RAN cells that are currently assigning a downlink dedicated physical channel DPCH or fractional downlink dedicated physical channel F-DPCH to the UE 236 may constitute the Active Set).

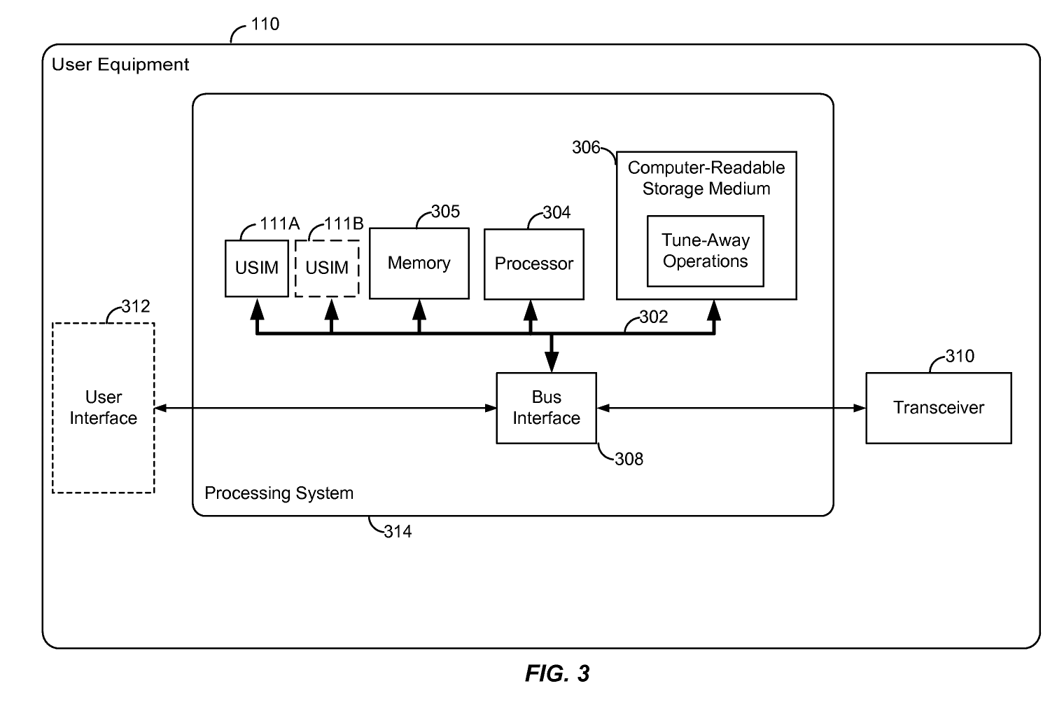

FIG. 3 is a block diagram illustrating an example of a hardware implementation for an apparatus (e.g., a UE 110 or a mobile station) employing a processing system 314. In accordance with various aspects of the disclosure, an element, or any portion of an element, or any combination of elements may be implemented with a processing system 314 that includes one or more processors 304. Examples of processors 304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 314 may be implemented with a bus architecture, represented generally by the bus 302. The bus 302 may include any number of interconnecting buses and bridges depending on the specific application of the processing system 314 and the overall design constraints. The bus 302 links together various circuits or components including one or more processors (represented generally by the processor 304), a memory 305, computer-readable media (represented generally by the computer-readable medium 306), and one or more USIMs (e.g., dual USIMs 111A and 111B). The bus 302 may also link various other circuits such as timing sources, peripherals, voltage regulators, and power management circuits, which are well known in the art, and therefore, will not be described any further. A bus interface 308 provides an interface between the bus 302 and a transceiver 310. The transceiver 310 provides a means for communicating with various other apparatus over a transmission medium.

In some examples of a multi-SIM device such as the illustrated UE 110 including two USIMs 111A and 111B, even though each USIM may be utilized by different subscriptions or networks, the subscriptions may share a single transceiver 310. However, while the examples detailed herein relate to UEs that utilize a single transceiver 310, and methods for performing the below-described tune-away utilizing that single transceiver, the broad concepts described herein may also be applicable to devices having two or more transceivers 310.

Depending upon the nature of the apparatus, a user interface 312 (e.g., keypad, display, speaker, microphone, joystick) may also be provided. The processor 304 is responsible for managing the bus 302 and general processing, including the execution of software stored on the computer-readable medium 306. The software, when executed by the processor 304, causes the processing system 314 to perform the various functions described infra for any particular apparatus. The computer-readable medium 306 may also be used for storing data that is manipulated by the processor 304 when executing software.

One or more processors 304 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 306. The computer-readable medium 306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 306 may reside in the processing system 314, external to the processing system 314, or distributed across multiple entities including the processing system 314. The computer-readable medium 306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

It may be the case that the UE 110 wishes simultaneously or concurrently to perform two different communication activities, including but not limited to connecting with two different networks, or two different subscriptions within the same network, or two cells in a cellular network. Particularly beneficial would be a UE 110 enabled to continue to be engaged in one of these ongoing communication activities (e.g., a CS voice call), while simultaneously performing another communication activity, such as receiving paging messages, performing SMS messaging, or receiving other information on a different subscription or from a different cell.

Thus, various aspects of the present disclosure provide for autonomous tune-aways during a voice call on one subscription for a multi-SIM operative mode, described in further detail below. With such autonomous tune-aways, a DSDS device (e.g., UE 110) is enabled, for example, to listen to paging channels for one subscription while maintaining a CS voice call for another subscription, using a single transceiver 310 and limiting the impact to the voice quality of the on going call. The tune-away operation is autonomous because the UE 110 does not communicate with a base station regarding the tune-away operation.

That is, in one or more aspects of the disclosure the UE 110 may be adapted to be enabled to perform two different activities concurrently (e.g., simultaneously), by temporarily tuning away from one activity to perform the other, before returning (tuning back) to the first activity. Aspects of the disclosure disclose a more optimal and efficient tuning away scheme, such that the first activity, from which the UE 110 tunes away, is not substantially compromised.

One aspect of the tune-away procedures disclosed herein lies in how it enables the UE 110 to use a single transceiver 310 to communicate with two cells or subscriptions in an efficient way, providing a low-cost solution with a relatively small compromise in performance.

To provide a straightforward understanding of various aspects of the disclosure, examples are provided below. In these examples, it may be assumed that one subscription is being used for circuit-switched communication (e.g., CS voice call), and another subscription is in an idle mode (referred to as the idle subscription or idle sub). As described below, during the circuit switched communication, the UE may periodically tune away and perform the idle activity with the same transceiver without substantially affecting the circuit-switched communication. These examples are illustrated using a UE that is operable in a GSM network. However, the present disclosure is not limited as such, and the examples may be implemented in other networks such as a UMTS network.

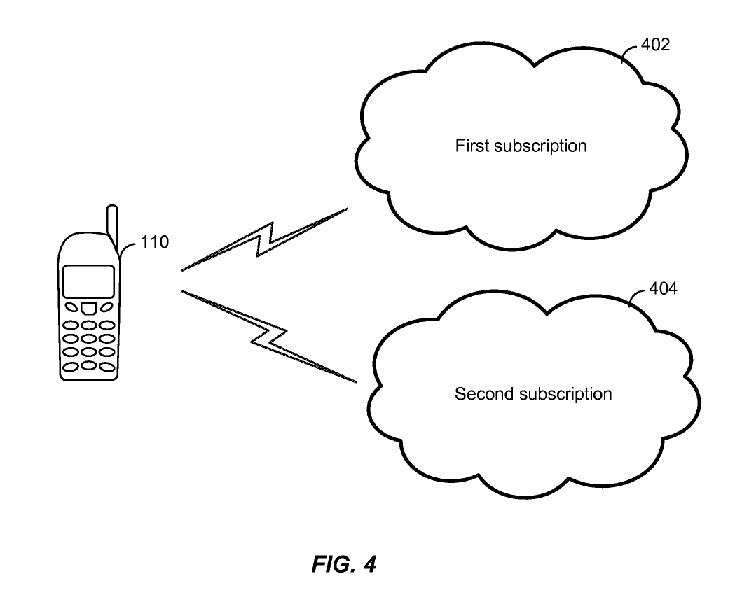

FIG. 4 is a drawing conceptually illustrating a DSDS UE 110 configured to concurrently operate in a first subscription 402 and a second subscription 404. The first subscription 402 and the second subscription 404 may be associated with the same wireless network or different wireless networks. For example, the first subscription 402 and the second subscription 404 may be associated with different GSM networks. Here, the UE 110 may be configured to be concurrently active on both subscriptions. In one aspect of the disclosure, the UE 110 may be configured to access both subscriptions using a shared transceiver 310. With the tune-away schemes, infra, the UE 110 can listen to signaling or control channels for one subscription (e.g., second subscription 404) while maintaining a voice call for the other subscription (e.g., first subscription 402), using the shared transceiver 310 and limiting the impact to the voice quality of the on going call. In GSM, by way of example and not limiting, a control channel multiframe has 51 TDMA frames with duration of 235.4 millisecond (ms), and a traffic channel multiframe has 26 TDMA frames with duration of 120 ms. In some aspects of the disclosure, the first subscription 402 and the second subscription 404 may correspond to different frequencies, timeslots, training sequence codes, radio access technologies, scrambling codes, or a combination thereof.

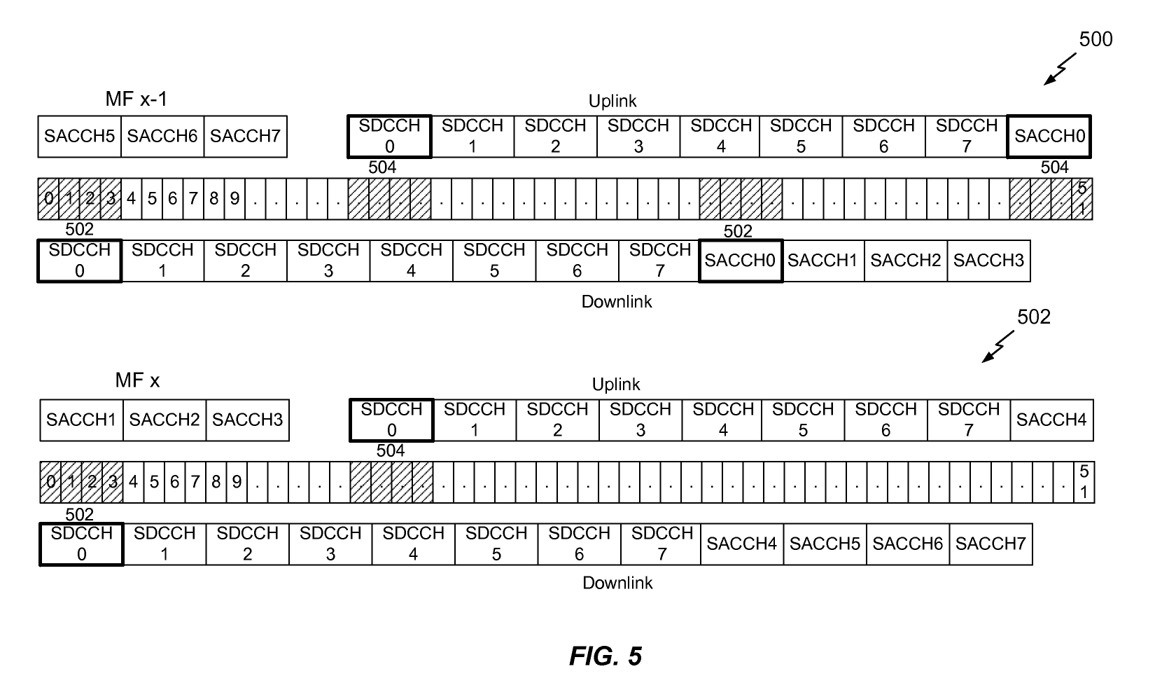

FIG. 5 is a drawing illustrating the physical channel structure for GSM during a call setup phase. Here, a 51-multiframe is used, and illustrated are two such multiframes 500 and 502 (MF x−1 and MF x). In GSM, after a UE 110 (or mobile station) is paged, the UE 110 requests a radio resource; this radio resource is called a standalone dedicated control channel (SDCCH), which is generally used for signaling and call setup between the UE 110 and the base transceiver station (BTS). In one example, the physical channel structure is an SDCCH channel by 8, which means that up to 8 different UEs or mobile stations can share this channel in a time-division fashion. In FIG. 5, it is illustrated that a UE 110 is assigned an SDCCH with index 0 (SDCCH0). The UE 110 is additionally assigned a slow associated control channel with index 0 (SACCH0), which in this aspect only appears on one of the two multiframes. The UE 110 receives in portions 502 and transmits in portions 504 of the 51-multiframe.

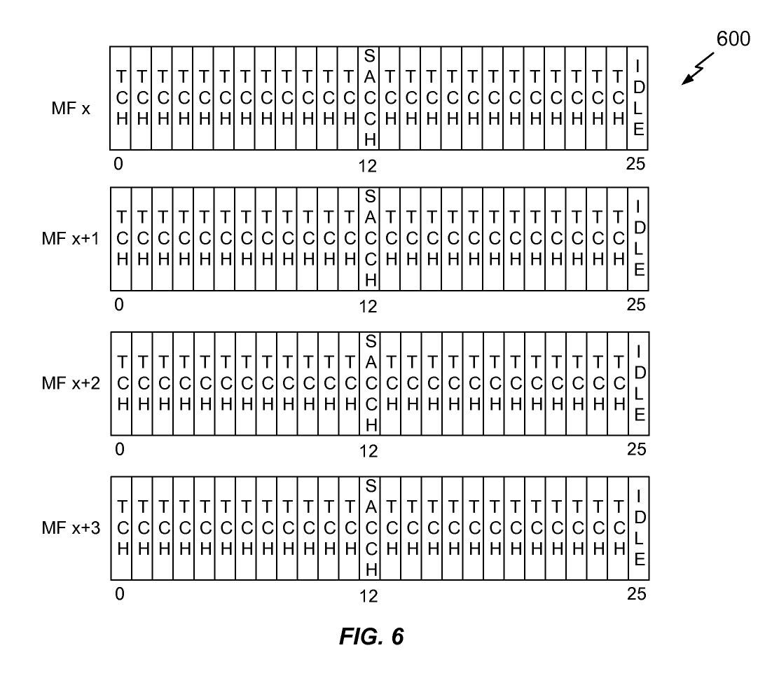

FIG. 6 is a drawing illustrating the physical channel structure 600 of the traffic channels (TCH) in a GSM network during an ongoing call. The TCH channels are used to carry encoded speech and data to and from the UE 110. Encoded speech is voice audio that is converted into digital form and compressed. GSM divides up each absolute radio-frequency channel number (ARFCN) into 8 time slots. These 8 time slots are further broken up into logical channels. Different time slots will carry different logical channels, depending on the structure the base station subsystem (BSS) uses. Here, four 26-multiframes (MF x, MF x+1, MF x+2, MF x+3) are shown in FIG. 6. Each of the multiframes includes 26 frames: 24 traffic frames labeled TCH, one idle frame labeled IDLE (frame 25), and one SACCH frame (frame 12). TCH frames carry voice packets and acknowledged mode control messages in both directions. SACCH carries un-acknowledged mode control messages in both directions. However, it will be appreciated that the present disclosure is not limited to the above-described multiframes arrangements, and other suitable arrangements may be implemented.

According to aspects of the disclosure, the UE 110 is enabled to receive page messages on one subscription (e.g., second subscription of FIG. 4) while circuit-switched communication (e.g., a CS voice call) is ongoing on the other subscription (e.g., first subscription of FIG. 4), In one aspect of the disclosure, a voice call tune-away procedure for briefly tuning away from the voice call to listen to the channels for the other subscription will be described below in more detail as an example.

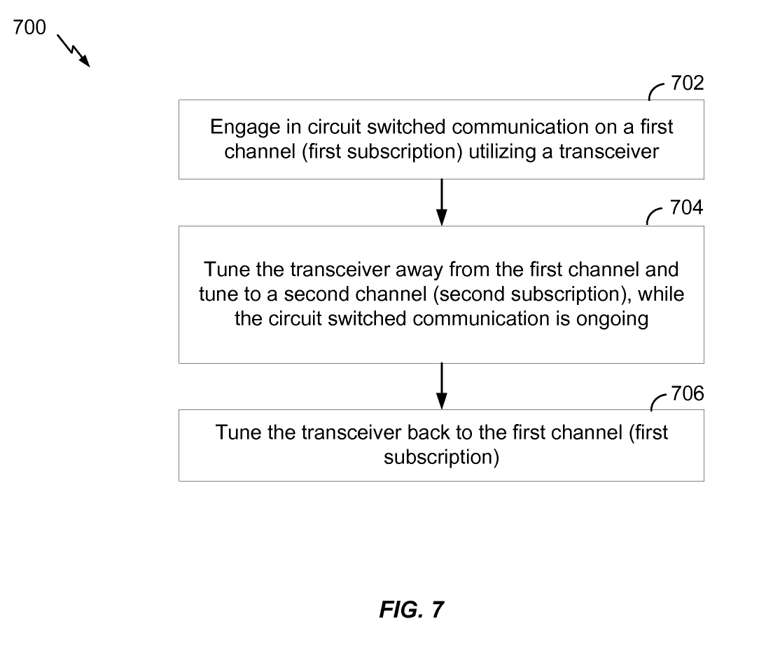

FIG. 7 is a flow chart 700 illustrating a tune-away scheme according to an aspect of the disclosure. By way of example, a multi-SIM UE 110 (e.g., a DSDS mobile station) is capable of communicating with a first subscription 402 using a first USIM 111A and a second subscription 404 using a second USIM 111B via the transceiver 310. In block 702, the multi-SIM UE 110 may engage in circuit switched communication (e.g., CS voice call) utilizing a first channel (e.g., TCH channels) corresponding to the first subscription 402 using the first USIM 111A, and, in block 704, the multi-SIM UE 110 autonomously tunes the transceiver 310 away from the first channel and tunes to a second channel (e.g., control channels 500 and 502) corresponding to the second subscription 404 using the second USIM 111B, while the circuit switched communication is ongoing. Here, the multi-SIM UE 110 is autonomous in performing the tune-away procedures because the UE 110 does not communicate to the networks (e.g., BTS 108) associated with the first and second subscription 402 and 404 about the turn-away operations. When the multi-SIM UE 110 is tuned to the second channel, it may perform suitable call establishment activities with the second subscription 404 to obtain caller identity information. Then, in block 706, the multi-SIM UE 110 autonomously tunes the transceiver 310 back to the first channel such that the quality of the circuit switched communication is not substantially affected.

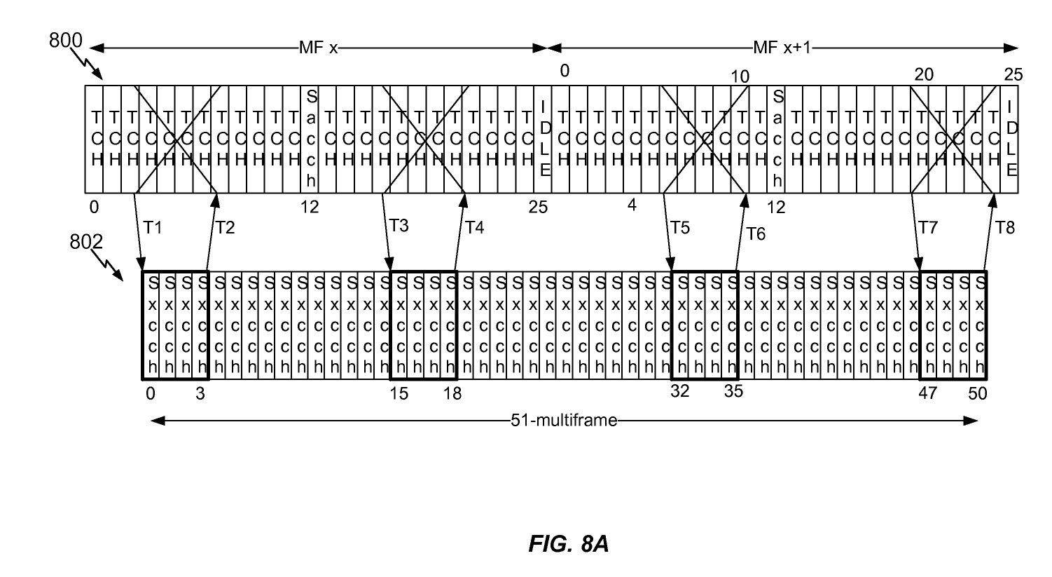

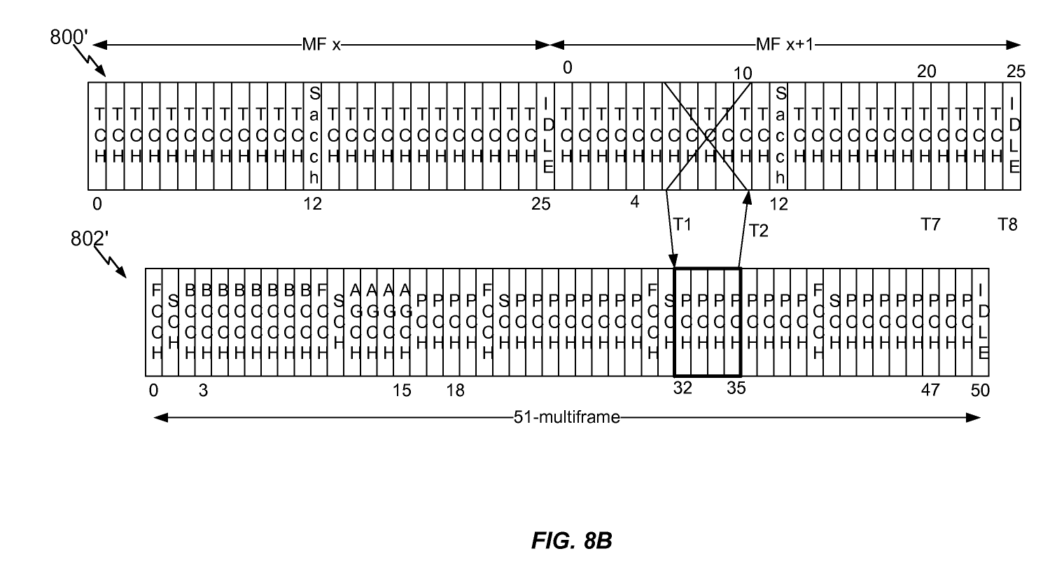

FIG. 8A is a drawing illustrating the voice call tune-away scheme of FIG. 7 according to an aspect of the disclosure. The UE 110 is engaged in a circuit switched voice call with a first subscription (e.g., 702 in FIG. 7), and two of the 26-multiframes MF x and MF x+1 of a traffic channel 800 are shown as an example in FIG. 8A. At a designated time, the UE 110 may tune away from the traffic channel 800 of the first subscription, and transmit or receive on a call setup channel 802 corresponding to the second subscription. In one example, the call setup channel 802 has a 51-multiframe structure in FIG. 8A. Each frame (SxCCH) of the 51-multiframe may be a SDCCH or SACCH. These steps correspond to blocks 704 and 706 of FIG. 7. For example, the UE 110 may tune to the second subscription at time points T1, T3, T5, and T7; and tune back to the first subscription at time points T2, T4, T6, and T8. During frames 0-3, 15-18, 32-35, and 47-50 of the 51-multiframe, the UE 110 may transmit or receive control and signaling messages on the second subscription, for example, to receive call notification or to perform call setup procedures. In another example, the tune-away to receive page channel from common control channel structure is shown in FIG. 8B. For example, at the time points T1, the UE 110 may tune away from the first subscription 800′ to listen to page messages on the second subscription 802′. The UE 110 may include a timing reference (e.g., an internal clock or timer provided by the processor 304) to provide the tune-way timings. For example, the timing reference may be synchronized with the system time broadcasted by the first subscription and or the second subscription.

In one example, as per 3GPP spec 05.02, the traffic channel 26-multiframe (e.g., MF x and MF x+1) of the first subscription repeats the same format at a rate of 26 TDMA frames with a duration of 120 ms. Every 12^{th} of the 26 frames is a SACCH frame which is used to assess the radio link in downlink (DL) by the UE 110 and uplink (UL) by the network. The 26-multiframe includes 6 speech frames/blocks (6*4=24 TDMA frames), and the SACCH and IDLE frames are the rest of the two frames. Therefore, a gap of 12 frames (12*4.615=55.38 ms) exists between the SACCH frame and the IDLE frame (e.g., frames 0 to 11 and frames 13 to 24). Depending on the type of speech code being used, not all frames are being used (e.g., in discontinuous transmit mode (DTX)) for voice call all the time. For example, for voice call using non-AMR codecs, when no signaling or speech is to be transmitted, some frames are occupied by the silence descriptor (SID) frame. Therefore, in one aspect of the disclosure, it is possible to tune away from the first subscription when the UE 110 detects that the voice call is inactive or substantially silent. Accordingly, the quality of the voice call may not be substantially affected if the timing of tuning away from the first subscription is suitably chosen.

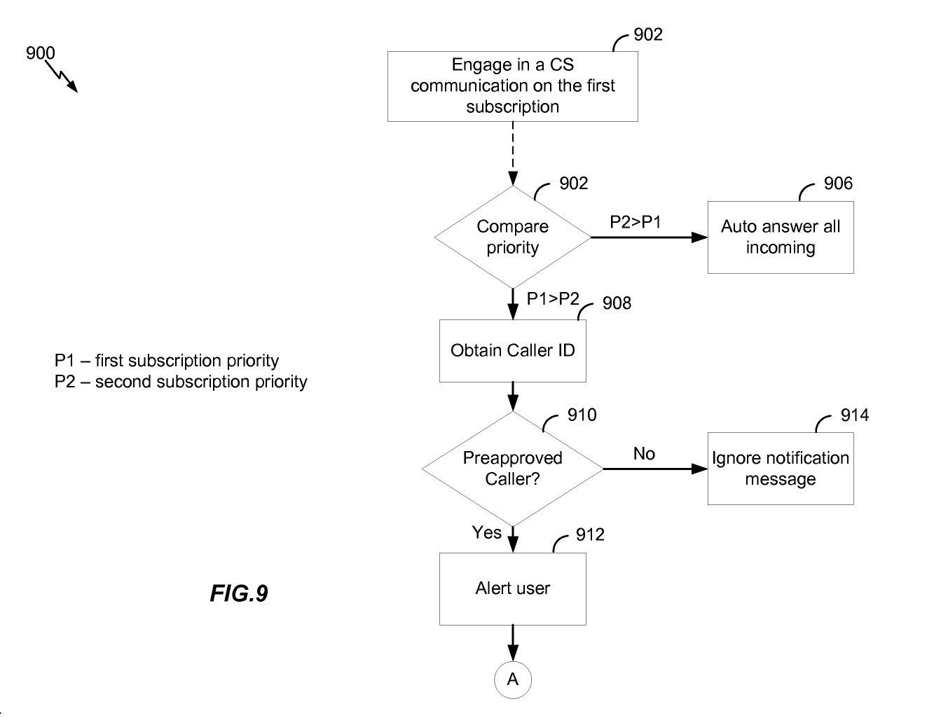

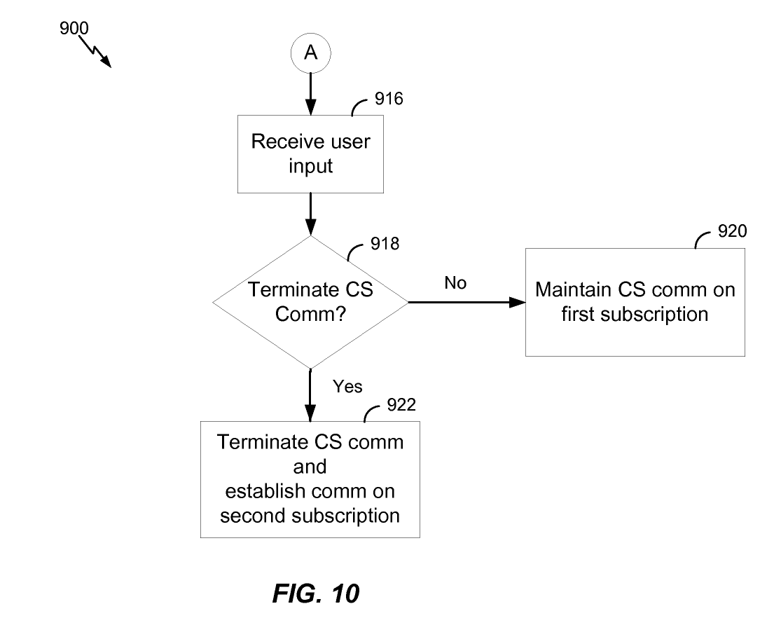

FIGS. 9 and 10 are a flowchart 900 illustrating a tune-away scheme according to aspects of the disclosure. Referring to FIG. 9, a multi-SIM UE 110 capable of being concurrently active on two subscriptions is being used on a first subscription for circuit-switched (CS) communication (e.g., voice call). In addition, the UE 110 can tune away from the first subscription to receive or transmit messages on a second subscription according to the tune-away scheme of FIG. 8. In some aspects of the disclosure, the UE 110 may be user configurable to assign priority to each of the subscription. For example, the first subscription may have higher or lower priority than that of the second subscription, or the subscriptions may have the same priority.

In block 902, the UE 110 is engaging in CS communication (e.g., voice call) on the first subscription. At this time, if the first subscription has higher priority than that of the second subscription, the UE 110 may not apply the tune-away scheme. However, if the first and second subscriptions have the same priority, or the second subscription has higher priority than that of the first priority, the UE 110 may apply the tune-away scheme so as to be concurrently active on both subscriptions and receive messages on the second subscription while the CS communication is ongoing on the first subscription. When the UE 110 is tuned to the second subscription, the UE 110 may receive a notification message (e.g., a page message) from a channel (e.g., PCH) of the second subscription. The notification message may indicate an incoming call on the second subscription.

In block 904, the priorities of the subscriptions are compared to each other. In one aspect, if the first subscription has a lower priority than that of the second subscription, the UE 110 may terminate the ongoing circuit switched communication on the first subscription, and establish communication on the second subscription. For example, the UE 110 may utilize the RACH, AGCH, SDCCH and SACCH channels to setup connection on the second subscription. In block 906, the UE 110 may terminate an ongoing voice call on the first subscription and always answer all incoming calls automatically on the second subscription.

In another aspect of the disclosure, if the second subscription has a higher priority than that of the first subscription, the UE 110 may not automatically answer all incoming communications from the second subscription. For example, when the UE 110 receives a notification message from the second subscription, indicating that an incoming call occurs on the second subscription, in block 908, the UE 110 may be configured to perform suitable call establishment procedures utilizing signaling/controlling channels (e.g., RACH, AGCH, SDCCH, or SACCH) on the second subscription, and to determine identity information (e.g., caller ID) corresponding to a source of the notification message. Then, the UE 110 is configured to selectively alert a user to the identity information of the notification message.

In block 910, the UE 110 may be configured to determine whether or not the identity information corresponds to a preapproved caller. For example, the UE 110 may store a list of preapproved callers in the memory 305 and or computer-readable storage medium 306. In block 912, if the identity information corresponds to a preapproved caller, the UE 110 may alert the user to the identity information. The UE 110 may notify the user using the user interface 312 that may be configured to generate an audio alert, a visual alert, or other suitable alerts. In block 914, if the identity information does not correspond to a preapproved caller, the UE 110 may ignore the notification message.

Referring to FIG. 10, in block 916, after alerting the user on the identity information, the UE 110 may receive an input from the user. The user may utilize the user interface 312 to response. For example, the user may enter the input by pressing a key on a keypad or touching a soft key on a touch screen. In block 918, the UE 110 determines whether or not the user chooses to terminate the ongoing circuit switched communication on the first subscription. In block 920, the user may choose to maintain the circuit switched communication on the first subscription. Alternatively, in block 922, the user may choose to terminate the circuit switched communication on the first subscription and establish communication on the second subscription. For example, the UE 110 may establish a voice call on the second subscription.

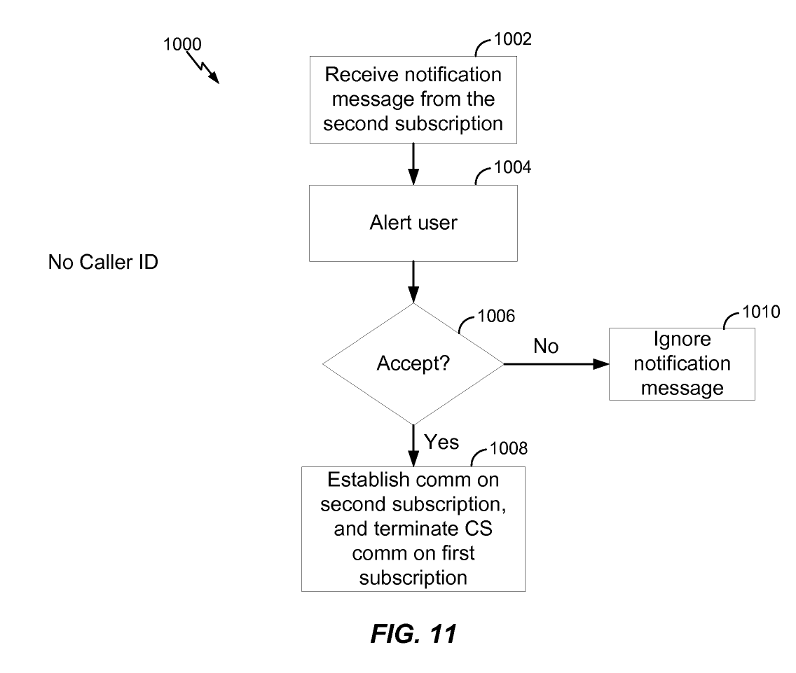

FIG. 11 is a flowchart 1000 illustrating a tune-away scheme according to another aspect of the disclosure. Referring to FIG. 11, a UE 110 capable of being concurrently active on two networks is being used on a first subscription for circuit-switched CS communication (e.g., voice call). In addition, the UE 110 can be configured to tune away from the first subscription to receive or transmit messages on a second subscription according to the tune-away scheme of FIG. 8. However, if the first subscription has higher priority than that of the second subscription, the UE 110 may not apply the tune-away scheme. If the first and second subscriptions have the same priority, or the second subscription has higher priority than that of the first priority, the UE 110 may apply the tune-away scheme so as to be concurrently active on both subscriptions and receive messages on the second subscription. When the UE 110 is tuned to the second subscription, in block 1002, the UE 110 may receive a notification message (e.g., a page message) from a channel (e.g., PCH) of the second subscription. The notification message may indicate an incoming call on the second subscription. Different from the example illustrated in FIGS. 9 and 10, the UE 110 will not go through call establishment procedures on the second subscription to obtain identity information in response to receiving the notification message.

In block 1004, in receipt of the notification, the UE 110 may alert the user to an incoming communication request on the second subscription. For example, the incoming communication request may come from a signaling channel (e.g., SDCCH or SACCH). The UE 110 may alert the user using a user interface 312 that may be configured to generate an audio alert, a visual alert, or other suitable alerts. In block 1006, the user may accept or reject the incoming communication on the second subscription. The user may utilize the user interface 312 to response. For example, the user may enter the input by pressing a key on a keypad or touching a soft key on a touch screen.

In block 1008, if the user accepts the incoming communication request, the UE 110 establishes communication on the second subscription and terminates the ongoing circuit switched communication on the first subscription. For example, the UE 110 may utilize signaling channels (e.g., SDCCH or SACCH) to establish communication on the second subscription. In block 1010, if the user does not accept the incoming communication request, the UE 110 may ignore the notification message and maintain the ongoing communication on the first subscription.

In one configuration, a UE 110 (e.g., a mobile station) capable of communicating with a first subscription and a second subscription via a transceiver 310, includes: means for engaging in circuit switched communication utilizing a first channel corresponding to the first subscription; means for tuning the transceiver away from the first channel and tuning to a second channel corresponding to the second subscription, while the circuit switched communication is ongoing; and means for tuning the transceiver back to the first channel. In one aspect, the aforementioned means may be the processor(s) 304 in which the invention resides from FIG. 3 configured to perform the functions recited by the aforementioned means. In another aspect, the aforementioned means may be a module or any suitable apparatus configured to perform the functions recited by the aforementioned means.

Several aspects of a telecommunications system have been presented with reference to a GERAN system. As those skilled in the art will readily appreciate, various aspects described throughout this disclosure may be extended to other telecommunication systems, network architectures and communication standards.

By way of example, various aspects may be extended to systems employing UMTS (FDD, TDD), Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication operable at a multi-SIM mobile station capable of communicating with a first subscription associated with a first USIM and a second subscription associated with a second USIM via a transceiver, the method comprising:
engaging in circuit switched communication utilizing a first channel corresponding to the first subscription associated with the first USIM;
autonomously tuning the transceiver away from the first channel and tuning to a second channel corresponding to the second subscription associated with the second USIM, while the circuit switched communication is ongoing; and
autonomously tuning the transceiver back to the first channel.

2. The method of claim 1, wherein the circuit switched communication comprises a voice call.

3. The method of claim 1, further comprising receiving a notification message transmitted on the second channel corresponding to the second subscription.

4. The method of claim 3, wherein the notification message comprises a page message corresponding to the second subscription.

5. The method of claim 3, further comprising:
if the first subscription has a lower priority than that of the second subscription,
terminating the circuit switched communication corresponding to the first subscription, and
establishing communication utilizing the second channel corresponding to the second subscription.

6. The method of claim 3, further comprising:
performing call establishment procedures utilizing the second channel corresponding to the second subscription; and
determining identity information corresponding to a source of the notification message.

7. The method of claim 6, further comprising selectively alerting a user to the identity information of the notification message.

8. The method of claim 7, wherein the selectively alerting the user to the identity information comprises:
if the identity information corresponds to a preapproved caller, alerting the user to the identity information; and
if the identity information does not correspond to a preapproved caller, ignoring the notification message corresponding to the second subscription.

9. The method of claim 7, further comprising:
responsive to an input of the user,
terminating the circuit switched communication corresponding to the first subscription, and
establishing communication utilizing the second channel corresponding to the second subscription.

10. The method of claim 9, wherein the establishing communication utilizing the second channel comprises establishing a voice call on the second subscription.

11. The method of claim 1, wherein the first subscription and the second subscription correspond to different frequencies, radio access technologies, scrambling codes, or a combination thereof.

12. The method of claim 1, further comprising:
alerting a user to an incoming communication request on the second channel corresponding to the second subscription; and
if the user selects to accept the incoming communication request, establishing communication utilizing the second channel corresponding to the second subscription, and terminating the ongoing circuit switched communication on the first channel.

13. The method of claim 12, wherein the establishing communication utilizing the second channel comprises establishing a voice call on the second subscription.

14. The method of claim 1, further comprising performing the tuning away from the first channel and the tuning back to the first channel during a multiframe corresponding to the first subscription.

15. The method of claim 14, further comprising maintaining a timing reference corresponding to the second subscription for performing the tuning to the second channel.

16. A multi-SIM mobile station capable of communicating with a first subscription associated with a first USIM and a second subscription associated with a second USIM via a transceiver, comprising:
means for engaging in circuit switched communication utilizing a first channel corresponding to the first subscription associated with the first USIM;
means for autonomously tuning the transceiver away from the first channel and tuning to a second channel corresponding to the second subscription associated the second USIM, while the circuit switched communication is ongoing; and
means for autonomously tuning the transceiver back to the first channel.

17. A computer program product, comprising a computer-readable storage medium comprising code for causing a multi-SIM mobile station capable of communicating with a first subscription associated with a first USIM and a second subscription associated with a second USIM via a transceiver to:
engage in circuit switched communication utilizing a first channel corresponding to the first subscription associated with the first USIM;
autonomously tune the transceiver away from the first channel and tune to a second channel corresponding to the second subscription associated with the second USIM, while the circuit switched communication is ongoing; and
autonomously tune the transceiver back to the first channel.

18. A multi-SIM mobile station capable of communicating with a first subscription and a second subscription, comprising:
at least one processor;
a first USIM associated with the first subscription and coupled to the at least one processor;
a second USIM associated with the second subscription and coupled to the at least one processor;
a transceiver coupled to the at least one processor; and
a memory coupled to the at least one processor,
wherein the at least one processor is configured to:
engage in circuit switched communication utilizing a first channel corresponding to the first subscription associated with the first USIM;
autonomously tune the transceiver away from the first channel and tune to a second channel corresponding to the second subscription associated with the second USIM, while the circuit switched communication is ongoing; and
autonomously tune the transceiver back to the first channel.

19. The mobile station of claim 18, wherein the circuit switched communication comprises a voice call.

20. The mobile station of claim 18, wherein the at least one processor is further configured to receive a notification message transmitted on the second channel corresponding to the second subscription.

21. The mobile station of claim 20, wherein the notification message comprises a page message corresponding to the second subscription.

22. The mobile station of claim 20, wherein the at least one processor is further configured to:
if the first subscription has a lower priority than that of the second subscription,
terminate the circuit switched communication corresponding to the first subscription, and
establish communication utilizing the second channel corresponding to the second subscription.

23. The mobile station of claim 20, wherein the at least one processor is further configured to:
perform call establishment procedures utilizing the second channel corresponding to the second subscription; and
determine identity information corresponding to a source of the notification message.

24. The mobile station of claim 23, wherein the at least one processor is further configured to selectively alert a user to the identity information of the notification message.

25. The mobile station of claim 24, wherein the at least one processor is further configured to:
if the identity information corresponds to a preapproved caller, alert the user to the identity information; and
if the identity information does not correspond to a preapproved caller, ignore the notification message corresponding to the second subscription.

26. The mobile station of claim 24, wherein the at least one processor is further configured to:
responsive to an input of the user,
terminate the circuit switched communication corresponding to the first subscription; and
establish communication utilizing the second channel corresponding to the second subscription.

27. The mobile station of claim 26, wherein the at least one processor is further configured to utilize the second channel to establish a voice call on the second subscription.

28. The mobile station of claim 18, wherein the first subscription and the second subscription correspond to different frequencies, radio access technologies, scrambling codes, or a combination thereof.

29. The mobile station of claim 18, wherein the at least one processor is further configured to:
alert a user to an incoming communication request on the second channel corresponding to the second subscription; and
if the user selects to accept the incoming communication request, establish communication utilizing the second channel corresponding to the second subscription, and terminate the circuit switched communication ongoing on the first channel.

30. The mobile station of claim 29, wherein the at least one processor is further configured to utilize the second channel to establish a voice call on the second subscription.

31. The mobile station of claim 18, wherein the at least one processor is further configured to tune away from the first channel and tune back to the first channel during a multiframe corresponding to the first subscription.

32. The mobile station of claim 31, wherein the at least one processor is further configured to maintain a timing reference corresponding to the second subscription for performing the tuning to the second channel.
